(19) United States
(12) Patent Application Publication
(10) Pub. No.: US 2025/0097759 A1
(43) Pub. Date: Mar. 20, 2025

(54) CONTROL PLANE AND USER PLANE SUBNETWORK TECHNOLOGIES

(71) Applicant: Apple Inc., Cupertino, CA (US)

(72) Inventors: Christian Hofmann, Muenchen (DE); Ahmed Mohamed Ibrahim Hassan, Munich (DE); Dimitrios Alanis, Munich (DE); Milan Zivkovic, Munich (DE); Nikolai Bijovski Ribakov, Munich (DE); Panagiotis Botsinis, Munich (DE); Sameh M. Eldessoki, Munich (DE); Tarik Tabet, San Jose, CA (US)

(73) Assignee: Apple Inc., Cupertino, CA (US)

(21) Appl. No.: 18/806,596

(22) Filed: Aug. 15, 2024

Related U.S. Application Data
(60) Provisional application No. 63/583,177, filed on Sep. 15, 2023.

(51) Int. Cl. H04W 28/02; H04L 5/00

(52) U.S. Cl. CPC H04W 28/0268; H04L 5/0053; H04W 28/0273

(57) ABSTRACT

The present application relates to devices and components including apparatus, systems, and methods for employing subnetworks to communicate with cellular networks.

### RELATED APPLICATIONS

This application claims priority to U.S. Provisional Patent Application No. 63/583,177, filed Sep. 15, 2023 and entitled “CONTROL PLANE AND USER PLANE SUBNETWORK TECHNOLOGIES,” which is incorporated herein in its entirety.

### TECHNICAL FIELD

The present application relates to the field of wireless technologies and, in particular, to technologies to control plane and user plane subnetwork technologies.

### BACKGROUND

Third Generation Partnership Project (3GPP) Technical Specifications (TSs) define the air interface to be used for radio access networks. These 3GPP TSs provide that base stations control resource management, admission control, mobility, and scheduling that take place within the radio access networks. While centralized control of the air interface provides some advantages, it also reduces deployment flexibility.

### BRIEF DESCRIPTION OF THE DRAWINGS

FIG. 1 illustrates a network environment in accordance with some embodiments.

FIG. 2 illustrates the network environment and a corresponding protocol configuration in accordance with some embodiments.

FIG. 3 illustrates the network environment and a corresponding protocol configuration in accordance with some embodiments.

FIG. 4 illustrates the network environment and a corresponding protocol configuration in accordance with some embodiments.

FIG. 5 illustrates the network environment and a corresponding protocol configuration in accordance with some embodiments.

FIG. 6 illustrates a protocol configuration in accordance with some embodiments.

FIG. 7 illustrates a protocol configuration in accordance with some embodiments.

FIG. 8 illustrates a protocol configuration in accordance with some embodiments.

FIG. 9 illustrates a protocol configuration in accordance with some embodiments.

FIG. 10 illustrates a protocol configuration in accordance with some embodiments.

FIG. 11 illustrates a protocol configuration in accordance with some embodiments.

FIG. 12 illustrates a protocol configuration in accordance with some embodiments.

FIG. 13 illustrates a protocol header in accordance with some embodiments.

FIG. 14 is an operation flow/algorithmic structure in accordance with some embodiments.

FIG. 15 is another operation flow/algorithmic structure in accordance with some embodiments.

FIG. 16 is an example UE in accordance with some embodiments.

FIG. 17 is an example base station in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); the phrase “(A) B” means (B) or (A and B), that is, A is optional; and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

New immersive services and a wide range of applications with different latency, jitter, and throughput requirements can be anticipated as wireless networks evolve to Sixth Generation (6G) and beyond. These networks may support a variety of services such as extended reality (XR), vehicle-to-everything (V2X) communication, sensing, etc. Additionally, new types of devices with limited compute power or extreme battery constraints can be envisioned, which may require additional computational support.

Local networks, or “subnetworks,” may be used to enable communication among local devices and enhance performance or power saving on low-capability devices. Some potential use-cases include in-factory subnetworks (for example, cooperative robots in industrial settings), in-vehicle subnetworks (for example, wireless interconnection of sensors/components to avoid wiring), in-body subnetworks (for example, healthcare applications), and in-house subnetworks (for example, entertainment/education applications)

Co-located devices may create a subnetwork to achieve different aspects. Quality of service (QOS) may be improved when co-located devices create a subnetwork to achieve a higher data rate, lower latency, or better reliability (for example, lower block error rate (BER)). Power saving may be achieved by a subnetwork that enables local devices to reduce power consumption. Local communication may be enabled by co-located devices creating a subnetwork to exchange data locally within the subnetwork (for example, exchanging collected metrics or making local calls). Subnetworks may enable use of distributed computing by the co-located devices sharing computing capabilities with one another through the subnetwork. This may be beneficial when devices are not able to offload their computations to an edge server (for example, due to limited latency, power consumption, operator support, privacy, etc.). Co-located devices may create a subnetwork to improve mobility performance (for example, provide better mobility decisions). Co-located devices may create a subnetwork to extend cellular coverage. This may provide out-of-coverage co-located UEs access to a broader cellular network. Co-located devices may create a subnetwork to enable new devices with limited compute power or extreme battery constraints to support a simplified version of a control plane and user plane.

In some instances, some objectives of creating a subnetwork may conflict with others. For example, improving QoS may conflict with power saving. Hence, to achieve those different objectives, different deployment options may be desired for the design of the overall network/subnetwork architecture. Embodiments of the present disclosure describe subnetwork architectures for both control plane and user plane to enable deployment flexibility. Embodiments describe control plane (CP) and user plane (UP) architectures that allow one or more nodes of the subnetwork to communicate with nodes of a radio access network (RAN) in a manner similar current 3GPP New Radio (NR) CP/UP architectures. Embodiments also describe a subnetwork control plane (snCP) that represents a simplified and independent CP architecture with a significantly reduced complexity in comparison to a current NR CP architecture. This may include, example, leaner information elements (IEs) for simplified protocol stack logic and different procedures. Embodiments also describe a subnetwork user plane (snUP) that represents a simplified and independent UP architecture with a significantly reduced complexity and enhanced flexibility as compared to a current NR UP architecture. This may include, for example, a reduction and consolidation of different UP layer 2 (L2) layers).

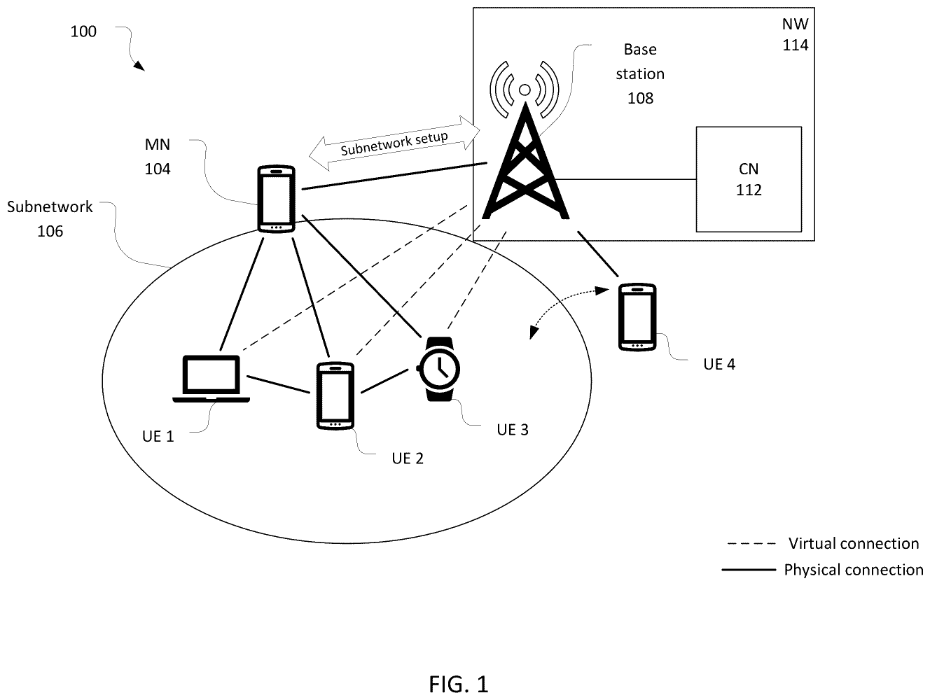

FIG. 1 illustrates a network environment 100 in accordance with some embodiments. The network environment 100 may include a base station 108 that provides one or more serving cells through which user equipments (UEs) may communicate with a cellular network. The base station 108 may be part of a RAN that is coupled with a core network (CN) 112. The RAN and CN 116 may be referred to, generically, as network (NW) 114.

The UEs and the base station 108 may communicate over air interfaces compatible with Fifth Generation (5G), 6G, (or later) system standards as provided by 3GPP technical specifications.

The network environment 100 may include a management node (MN) 104 communicatively coupled with the base station 108 through a physical connection provided by the serving cell of the base station 108. The MN 104 may be a UE that provides a coordination role within a subnetwork 106.

The subnetwork 106 may include a number of UEs coupled with the MN 104. For example, the subnetwork 106 may include UE 1, UE 2, and UE 3. Each of these UEs may include a physical connection with the MN 104 and a virtual connection with the BS 108. The network environment 100 may also include a UE 4 that has a physical connection with the base station 108.

A physical connection, as used herein, may refer to a direct wireless connection between two devices at a physical layer of a network protocol stack. A virtual connection as used herein, may refer to a logical link between two devices. This logical link may include connections at layers above the physical layer of the network protocol stack.

The subnetwork 106 may be controlled by the MN 104 independent from a broader network (for example, a RAN controlled by the base station 108 or the CN 112). For example, the subnetwork 106 may utilize a technology independent from the RAN technology. The subnetwork 106 may use licensed or unlicensed spectrum, resources of which are granted, scheduled, or otherwise controlled by the MN 104 independent from direct control by the base station 108.

The MN 104 may form the subnetwork 106 for the UEs without (or with limited) configuration or awareness by the base station 108. The base station 108 may communicate with the MN 104 via a physical connection and may communicate with the UEs of the subnetwork 106 logically over the virtual connections. In some embodiments, the subnetwork topology and mobility within the subnetwork 106 may be transparent to the broader network (for example, the base station 108), which may decrease complexity of the broader network. The MN 104 may control various aspects of the subnetwork 106 including, for example, routing and resource management. The MN 104 may provide the quality of service (QOS) that provides a reliable end-to-end (E2E) link. This may be enabled by utilizing a fair scheduling mechanism across all UEs of the subnetwork 106 and with respect to other UEs of the network environment 100.

CP and UP aspects of the subnetwork 106 may facilitate flexible and efficient communication of components of the subnetwork 106. For example, CP entities can be flexibly deployed on the MN 104 or local devices and can be transferred between subnetwork nodes. These deployments may be transparent to the broader network. With respect to the UP aspects, higher layers may terminate at a local device (e.g., protocol data unit (PDU) session/Internet protocol (IP) addresses), and lower layers may terminate at the MN 104 or other subnetwork nodes and may be subnetwork-specific within the subnetwork 106 depending on the technology used (for example, licensed vs. unlicensed, device-to-device (D2D), etc.).

In some embodiments, a UE may be associated with the broader network. For example, a UE of the subnetwork 106 may remain registered with the broader network and have some aspects managed by the base station 108. For example the base station 108 may include a UE context and may control resources and mobility decisions with respect to the broader network (for example, such as handover between base stations of a cellular network).

In some embodiments, a UE may be able to seamlessly move between the subnetwork 106 and a broader network controlled by the base station 108. For example, the network environment 100 may include UE 4 that is capable of transitioning into, and out of, the subnetwork 106.

The MN 104 may cooperate with the base station 108 to set up the subnetwork 106. The MN 104 and the base station 108 may each include MN-interface configurations to facilitate set up and downlink/uplink signaling with respect to the subnetwork 106.

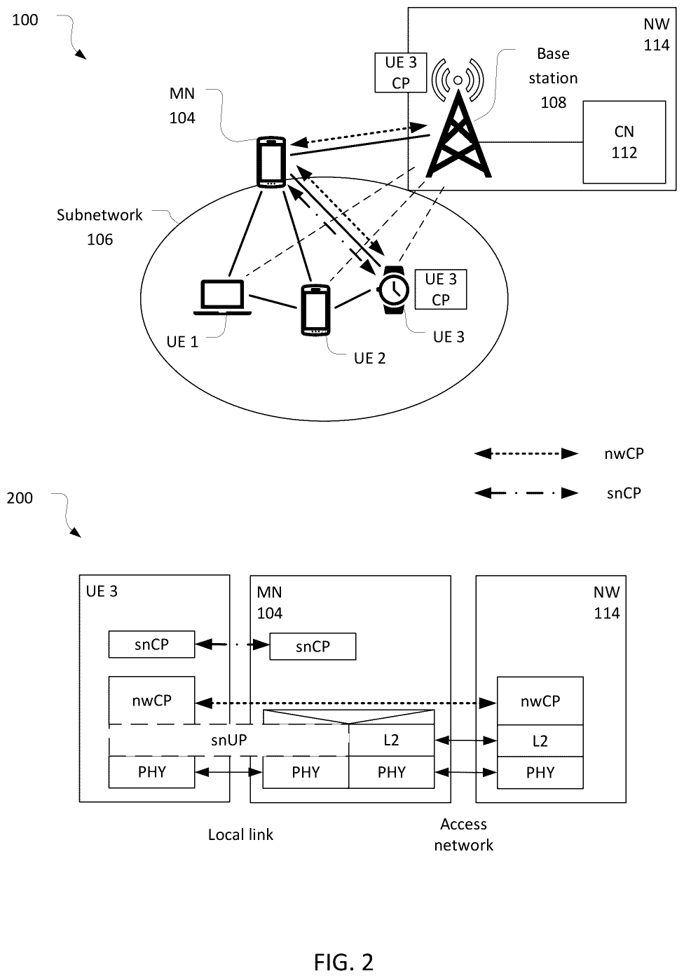

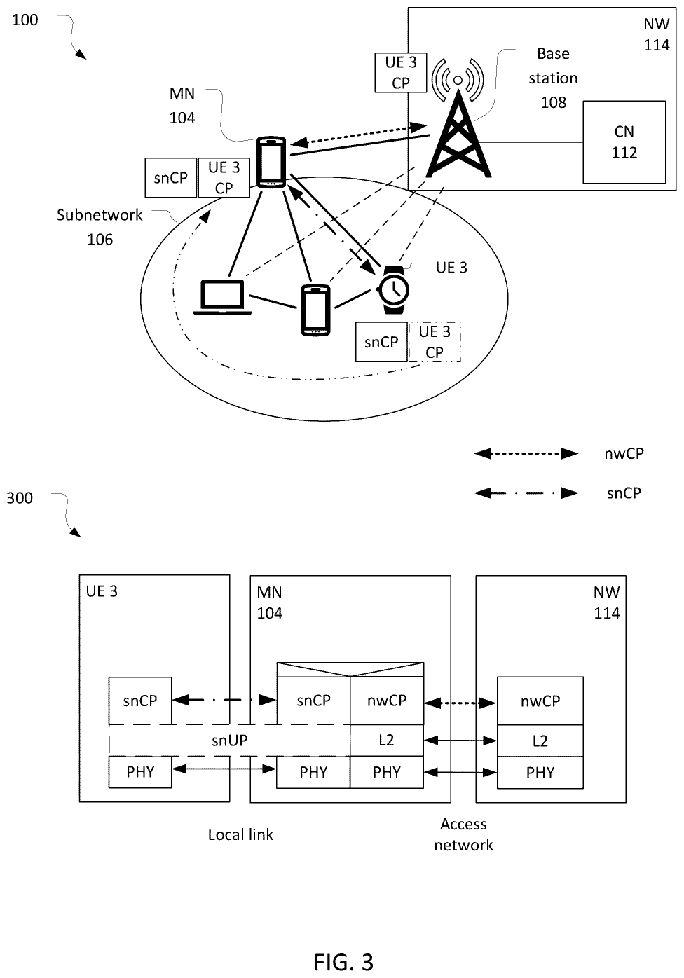

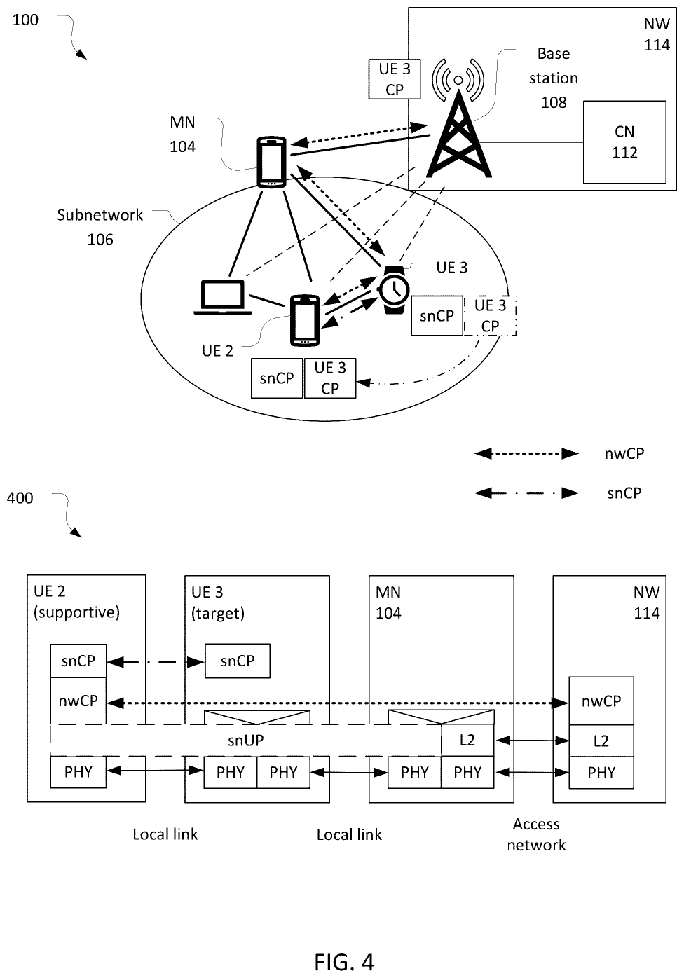

A first aspect of the disclosure describes an snCP. In a first option, described below with respect to FIG. 2, the subnetwork UEs route CP traffic through the subnetwork 206 in a manner transparent to the broader network. In a second option, described below with respect to FIG. 3, the CP traffic may be aggregated at a CP layer at the MN 204. In a third option, described below with respect to FIG. 4, the CP traffic for one subnetwork UE may be offloaded to a CP layer at another subnetwork UE.

FIG. 2 illustrates the network environment 100 and a corresponding protocol configuration 200 with respect to UE 3 in accordance with some embodiments.

The protocol configuration includes a CP layer at the base station 108 coupled with a CP layer at UE 3. Thus, the UE CP terminates at UE 3. The CP layers, which may also be referred to as network CP (nwCP) layers to differentiate from snCP layers, may communicate CP data from the network 114 to the UE 3 and vice versa. The MN 104 may transparently forward the CP data to the network 114 or the UE 3.

In the network 114, the nwCP layer may include a plurality of sublayers disposed on the base station 108 or the CN 112. For example, the base station 108 may include packet data convergence protocol (PDCP), radio link control (RLC), media access control (MAC), and radio resource control (RRC) sublayers and the CN 112 may include non-access stratum (NAS) sublayers at an access and mobility management function (AMF), for example. The nwCP layer of the UE 3 may have sublayers that correspond to the sublayers of the network 114.

Briefly, the RRC sublayer may be used to control: transmission of system and paging information; RRC connections; security, mobility, and QoS management functions; signaling radio bearers (SRBs) and data radio bearers (DRBs); link measurements; and radio link failures. The MAC sublayer may manage scheduling/priority handling, (de)multiplexing, and HARQ processes between logical channels and transport channels. The RLC sublayer may manage (re-)segmentation and error correction through automatic repeat request (ARQ) between logical channels and RLC channels. The PDCP sublayer may manage robust header (de)compression and security between radio bearers and RLC channels. The NAS sublayer may perform, for example, authentication, mobility management, and security control operations.

Except as otherwise described herein, the MAC, RLC, and PDCP sublayers may perform CP functions similar to that described in clause 6 of 3GPP TS 38.300 v17.5.0 (2023 Jun. 30), the RRC sublayer may perform CP functions similar to that described in clause 7 of 3GPP TS 38.300, and the NAS sublayer may perform CP functions similar to that described in 3GPP TS 23.501 v18.2.2 (2023 Jul. 7).

The protocol configuration 200 may also include an snCP layer at the MN 104 coupled with an snCP layer at UE 3. The snCP layer may be used to communicate CP messages that are specific to managing the communications within the subnetwork. The snCP layers may include sublayers similar to one or more of the sublayers described above with respect to the nwCP, except from the perspective of the subnetwork 106 instead of the NW 114. The snCP signaling between the snCP layers at the MN 104 and the UE 3 may be transparent to the NW 114.

The protocol configuration 200 may also include L2 and physical (PHY) layers at the MN 104 that are respectively coupled with L2 and PHY layers at the NW 114. These L2 layers may be used for transmitting UP traffic over an access network. The UP traffic may be transmitted over a local link, e.g., a wireless local area network (WLAN) link, via snUP as described elsewhere herein.

FIG. 3 illustrates the network environment 100 and a corresponding protocol configuration 300 with respect to UE 3 in accordance with some embodiments.

The protocol configuration 300 includes an nwCP layer at the network 114 coupled with an nwCP layer at the MN 104. Thus, the UE 3 nwCP terminates at the MN 104. In this manner, the UE 3 may offload its nwCP operation (or parts of it) to the MN 104.

The MN 104 may also have an snCP layer that is coupled with an snCP layer of the UE 3. The snCP may be transparent to the network 114 and may cover functionality of the subnetwork 106. The MN 104 and the UE 3 may use snCP signaling to communicate nwCP information that needs to be conveyed to, or sourced from, the UE 3.

The nwCP and snCP layers may be similar to those described above with respect to FIG. 2.

The protocol configuration 300 may also include L2 and PHY layers at the MN 104 that are respectively coupled with L2 and PHY layers at the NW 114. These L2 layers may be used for transmitting UP traffic over an access network. The UP traffic may be transmitted over a local link, e.g., a WLAN link, via snUP as described elsewhere herein.

FIG. 4 illustrates the network environment 100 and a corresponding protocol configuration 400 with respect to UE 3 in accordance with some embodiments.

The protocol configuration 400 includes an nwCP layer at the network 114 coupled with an nwCP layer at UE 2. Thus, the UE 3 nwCP terminates at UE 2. In this manner, the UE 3 may offload its nwCP operation (or parts of it) to UE 2, which may be operate in a supportive role.

In this embodiment, the base station 108 may communicate over a virtual connection with the UE 3. In the downlink, UE 3 may transparently forward nwCP messages to the UE 2. The nwCP layer at UE 2 may decode the nwCP messages. An snCP layer at UE 2 may then forward relevant information to an snCP layer at UE 3 with which it is coupled.

Transmission of CP information in the uplink may work in the opposite direction in a similar manner.

Except as otherwise described, the nwCP and snCP layers may be similar to those described above with respect to FIG. 2.

The protocol configuration 400 may also include L2 and PHY layers at the MN 104 that are respectively coupled with L2 and PHY layers at the NW 114. These L2 layers may be used for transmitting UP traffic over an access network.

The UP traffic may be transmitted over local links, e.g., WLAN links, between the MN 104, UE 3, and UE 2 via snUP as described elsewhere herein.

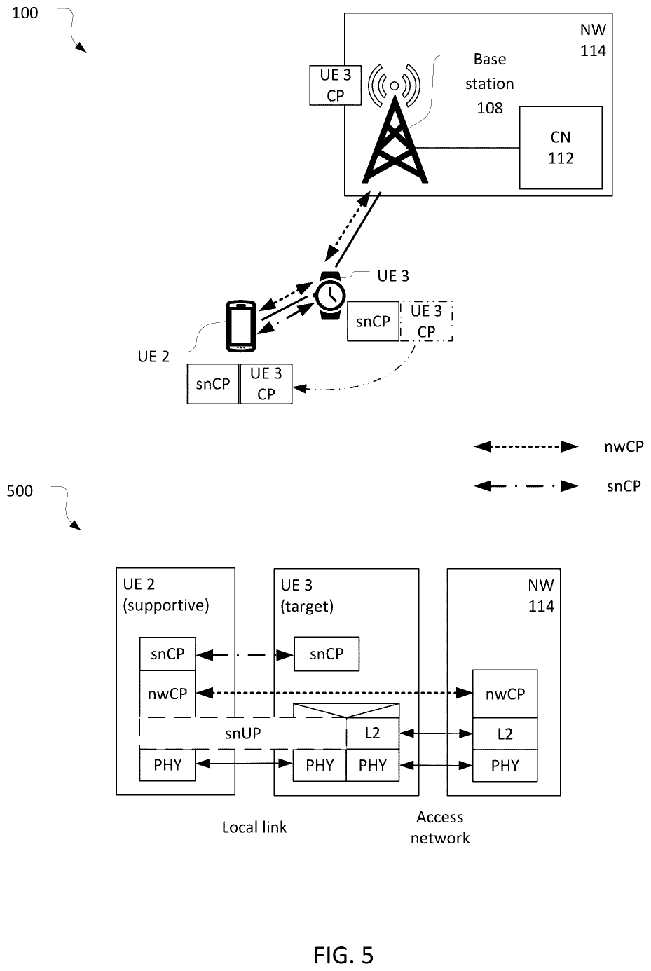

FIG. 5 illustrates portions of the network environment 100 and a corresponding protocol configuration 500 with respect to UE 3 in accordance with some embodiments.

The protocol configuration 500 may include UE 3 offloading nwCP operation (or parts of it) to UE 2 in a manner similar to protocol configuration 400. However, in this embodiment, the MN 104 is not involved and the base station 108 has a direct connection with the UE 3. Communication between a nwCP layer at the network 114 and an nwCP layer at UE 2, and between snCP layer at UE 2 and snCP layer at UE 3 may be similar to that described with respect to FIG. 4.

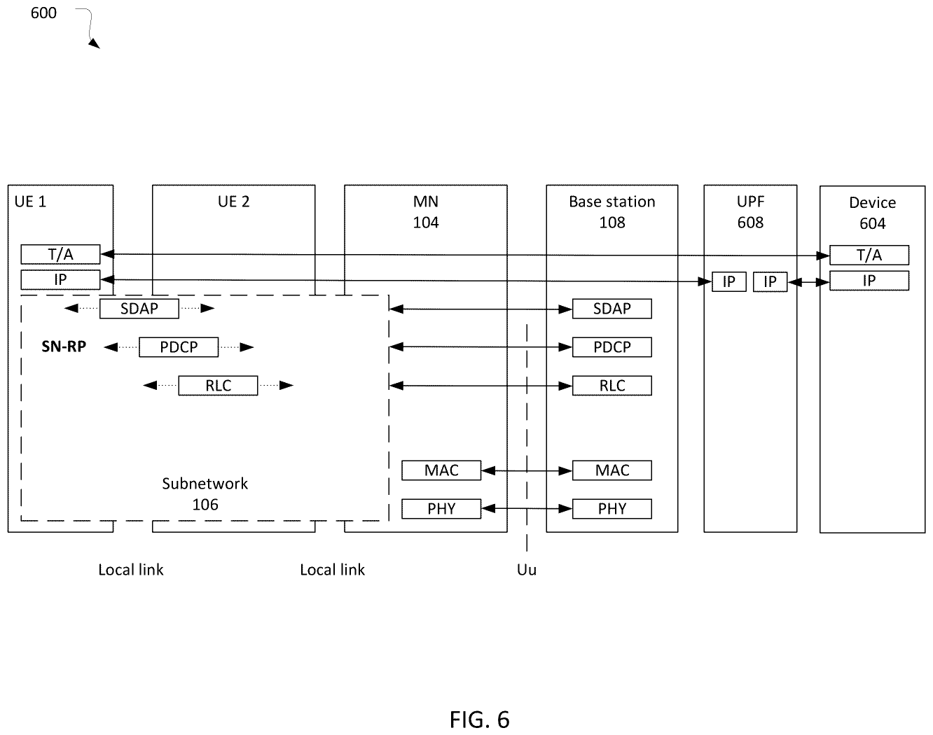

FIG. 6 illustrates a protocol configuration 600 for an snUP with flexible and transparent layer deployment of RAN-terminated protocol entities in accordance with a second aspect of the disclosure. The protocol configuration 600 may describe components of a user plane protocol stack distributed throughout devices of the network environment 100.

The protocol configuration 600 may include transport/application (T/A) layers (for example, transmission control protocol (TCP), etc.) of the UE 1 that is coupled with T/A layers of another device 604 (for example, server, UE, etc.) with which the UE 1 is communicating.

The protocol configuration 600 may further include IP layers at a user plane function (UPF), which may be disposed in the CN 112, that couple with respective IP layers in the UE 1 and the device 604. The IP layers may be used to transport IP packets across network boundaries using IP addresses in the packet headers.

The protocol configuration 600 may further include a service data adaptation protocol (SDAP) sublayer on the base station 108 that is coupled with an SDAP sublayer on a subnetwork UE. The SDAP sublayer may provide mapping between QoS flows and data radio bearers (DRBs) and may mark QoS flows IDs (QFIs) in uplink and downlink packets.

The protocol configuration 600 may further include a PDCP sublayer on the base station 108 that is coupled with a PDCP sublayer on a subnetwork UE. The PDCP sublayer may handle, for example, transfer of data, PDCP sequence numbers, header (de) compression, (de) ciphering, integrity checks, ordered delivery of packets, etc.

The protocol configuration 600 may further include an RLC sublayer on the base station 108 that is coupled with an RLC sublayer on a subnetwork UE. The RLC sublayer may handle, for example, transfer of upper-layer PDUs, sequence numbering, error correction, (re) segmentation, service data unit (SDU) reassembly/discard, etc.

The protocol configuration 600 may further include a MAC sublayer on the base station 108 that is coupled with a MAC sublayer on the MN 104. The MAC sublayer may handle, for example, mapping between logical and transport channels, (de) multiplexing MAC SDUs, hybrid automatic repeat request (HARQ) transmissions, priority handling, etc.

Except as described otherwise herein, the SDAP, PDCP, RLC, and MAC may perform layer 2 (L2) user plane functions such as that described in clause 6 of 3GPP TS 38.300.

Subnetwork termination points for the RAN-terminated UP protocols (for example, SDAP, PDCP, or RLC) may be dynamically configured on different subnetwork UEs based on objectives of a particular embodiment. This may be controlled by the MN 104 and agreed within the subnetwork 106 without any involvement from the network 114. Thus, the deployment of the L2 sublayers within the subnetwork 106 may be transparent to the base station 108.

The independent/transparent nature of the L2 sublayer deployment may enable different subnetwork solutions that may only involve alignment among the subnetwork UEs. No additional agreement/negotiation may be needed with the network 114.

A number of factors may be weighed when determining the most desired appointment within the subnetwork 106. For example, depending on the used subnetwork technologies, RLC signaling may be used to cover more than the cellular link interface over the Uu. In this manner, an RLC re-establishment procedure may be used to cover a path through the subnetwork that includes one or more local links.

Different deployments may be preferable in light of particular technologies and capabilities of local links. For example, some subnetwork UEs might want to rely on E2E PDCP ciphering for privacy reasons if, for example, intermediate nodes are not trusted or the L2 does not provide enough security. Such subnetwork UEs may agree with the MN 104 to host PDCP/SDAP sublayers. For another example, some subnetwork UEs might have a higher trust level among each other or the lower/higher layers may provide a strong encryption and those subnetwork UEs may want to offload the PDCP ciphering to the MN 104. In yet another example, some subnetwork UEs may have restrictive latency requirements (for example, using low-latency guaranteed bitrate bearers) and may want to have the SDAP terminate on the subnetwork UE in order to perform proper mapping. Other subnetwork UEs may have more relaxed latency requirements (for example, only best effort traffic with no particular prioritization or mapping to different bearers), so SDAP functionality may not be required at the UE.

To the extent the RAN-terminated UP protocol is located on a device of the subnetwork 106 other than the target (for example, UE 1 in FIG. 6), subnetwork routing protocol (SN-RP) layers may disposed on the device and the target to forward relevant information to the target. The SN-RP layers may deliver routing through the subnetwork 106 by, for example, generating SN-RP packets with routing-related information. The SN-RP may carry mapping information in-band per packet. This mapping information may be used to perform the next mapping step(s).

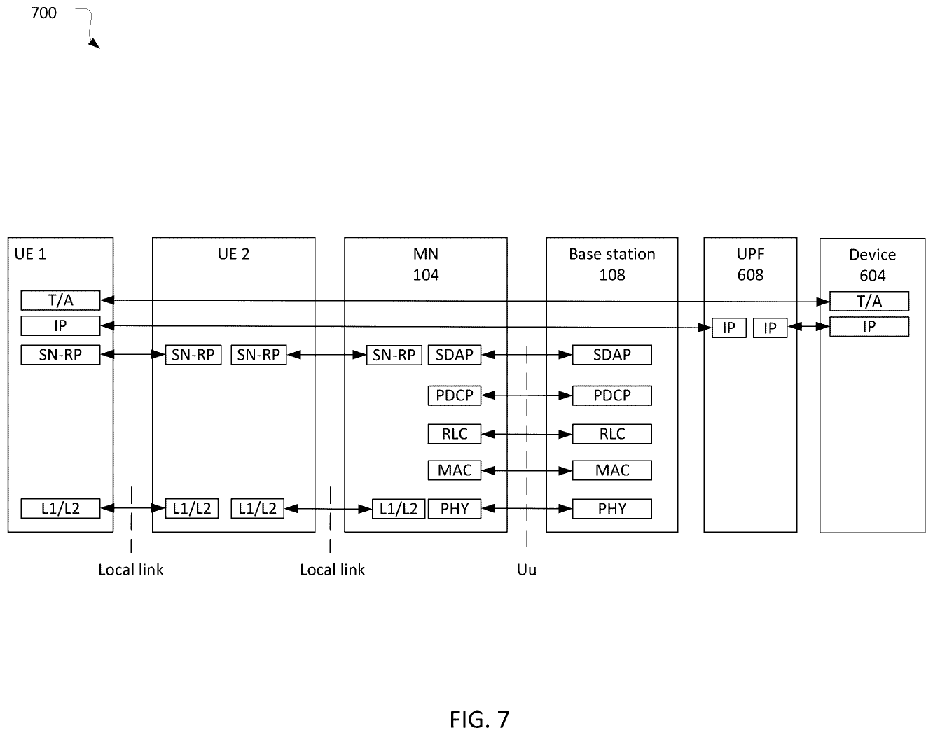

FIGS. 7-12 provide examples of various deployments of RAN-terminated protocol entities within the subnetwork 106 in accordance with some embodiments. The examples illustrate how different sublayers within the snUP may be flexibly deployed to exploit different link characteristics and UE capabilities. This may enable a wide array of use cases.

FIG. 7 illustrates a protocol configuration 700 with an SN-RP layer disposed below an IP layer on UE 1 in accordance with some embodiments.

IP/PDU sessions may terminate at UE 1, which may maintain QoS flow filtering per PDU session. On a PDU-session level, packets may be filtered and associated with certain QoS flows at UE 1 before being provided to SDAP on the MN 104 to perform the QoS flow-to-RB mapping.

The protocol configuration 700 may include the RAN-terminated UP protocols terminated at the MN 104. For example, the MN 104 may include SDAP, PDCP, RLC, and MAC sublayers that are coupled with respective sublayers in the base station 108.

The MN 104 may include an SN-RP layer that may be used to route information to, and receive information from, an SN-RP layer of UE 1. As shown, the routing may take place via an intermediate UE, for example, UE 2, which includes SN-RP layers that are coupled with SN-RP layers in the MN 104 and the UE 1. In other embodiments, the routing may take place via a plurality of intermediate UEs, or the MN 104 may have a direct connection with UE 1. The MN 104, UE 2, and UE 1 may each have L1/L2 layers (for example, PHY, MAC, or RLC) that enable direct connections with one another over technology-specific local links. The local link technology may be, for example, a WLAN technology, a wireless personal area networking (WPAN) technology, a sidelink technology, etc.

The protocol configuration 700 may perform uplink communications as follows. The UE 1 may assign QoS flow IDs by applying PDU session QoS filter rules. The SN-RP layer of UE 1 may mark SN-RP packets to identify a QoS flow or SRB ID. For example, a header of an SN-RP packet may include: a UE ID (for example, a source UE ID to identify the packet originator along the path within the subnetwork); and a PDU session ID together with a QoS flow ID or an SRB ID. The SN-RP signaling may carry the packets through the subnetwork 106 toward the MN 104. The intra-subnetwork nodes may use routing/priority policies based on SN-RP information elements. For example, SRBs may be prioritized over QoS flows or vice versa. Upon receiving the SN-RP packet, the SN-RP layer at the MN 104 may use the UE ID and PDU session ID to perform mapping to the SDAP sublayer. The SDAP sublayer may use the QoS flow ID to map user data carried in the SN-RP packet to an appropriate DRB/PDCP entity.

The protocol configuration 700 may perform uplink communications as follows. The MN 104 may receive packets from the access network (for example, the base station 108) over the Uu interface. The SN-RP layer of the MN 104 may generate SN-RP packets marked with information carried in SN-RP. For example, the SN-RP layer of the MN 104 may mark SN-RP packets to identify a QoS flow or SRB ID. For example, a header of an SN-RP packet may include: a UE ID (associated with UE 1); and a PDU session ID together with a QoS flow ID or an SRB ID. The SN-RP signaling may carry the packets through the subnetwork 106 toward the UE 1. The intra-subnetwork nodes may use routing/priority policies based on SN-RP information elements. For example, SRBs may be prioritized over QoS flows or vice versa.

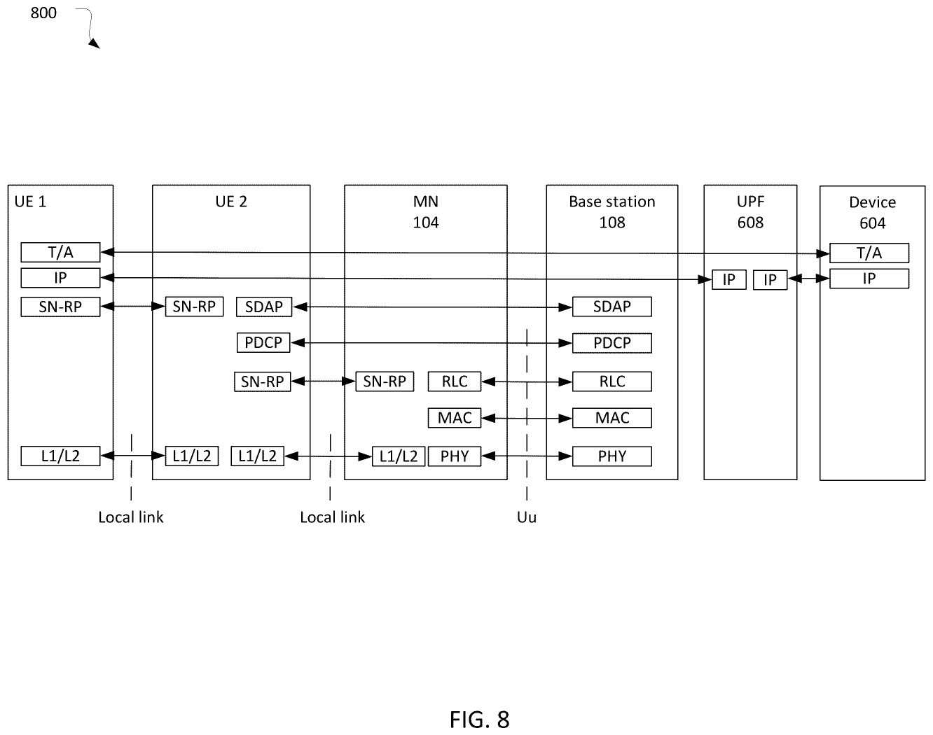

FIG. 8 illustrates a protocol configuration 800 with an SN-RP layer disposed directly below an IP layer on UE 1 in accordance with some embodiments.

IP/PDU sessions may terminate at UE 1, which may maintain QoS flow filtering per PDU session.

The protocol configuration 800 may include some RAN-terminated UP protocols terminated at the MN 104 and other RAN-terminated UP protocols terminated at an intermediate node, for example, UE 2. For example, the UE 2 may include SDAP and PDCP sublayers while the MN 104 includes RLC and MAC sublayers. The MN 104 may include an SN-RP layer coupled with an SN-RP layer of UE 2 and the UE 2 may include an additional SN-RP layer that is coupled with an SN-RP layer of UE 1.

The protocol configuration 800 may perform uplink communications as follows. UE 1 may assign QoS Flows IDs by applying PDU Session QoS filter rules. The SN-RP layer of UE 1 may generate SN-RP packets marked with information to identify the QoS Flow and SRB ID. For example, an SN-RP packet may include a UE ID (for example, a source UE ID to identify the packet originator along the path within the subnetwork); and a PDU session ID together with a QoS flow ID or an SRB ID. The SN-RP signaling may carry the packets through the subnetwork 106 toward UE 2. UE 2 may be configured to perform the security on behalf of UE 1. For example, the SN-RP layer of UE 2 may use the UE ID and PDU Session ID to perform mapping to SDAP. The SDAP layer of the UE 2 may use QoS Flow ID to DRB mapping to identify a correct PDCP entity. The other SN-RP layer of UE 2 may generate SN-RP packets marked with information to identify a radio bearer (RB). For example, an SN-RP packet may include a UE ID (associated with a subnetwork target of the packet, for example, MN 104) and an RB ID. SN-RP carries packets further through the subnetwork 106 toward the MN 104. The MN 104 may then use the UE ID and RB ID for RB-to-RLC mapping.

The protocol configuration 800 may perform downlink communications as follows. The MN 104 may receive packets via an access network (for example, base station 108) over the Uu interface. The SN-RP layer of the MN 104 may generate SN-RP packets marked with information to be carried by SN-RP. For example, the packets may include a UE ID (associated with a subnetwork target of the packet, for example, UE 2) and an RB ID. The SN-RP signaling may carry the packets through the subnetwork 106 toward the UE 2. Intra-subnetwork nodes may use routing/priority policies based on SN-RP information elements (for example, prioritize SRB over QoS flows or vice versa). The UE 2 may perform security on behalf of UE 1. The SN-RP layer of UE 2 may map the packets based on UE ID and DRB ID to the proper PDCP entity and the PDCP/SDAP sublayers may perform PDCP/SDAP functionality. The other SN-RP layer of the UE 2 may generate SN-RP packets marked with information carried in SN-RP, for example, a UE ID (associated with subnetwork target of the packet, for example, UE 1); and a PDU session ID together with a QoS flow ID or an SRB ID. The SN-RP signaling may carry the packets through the subnetwork 106 toward the UE 1, which may then perform IP/T/A functions.

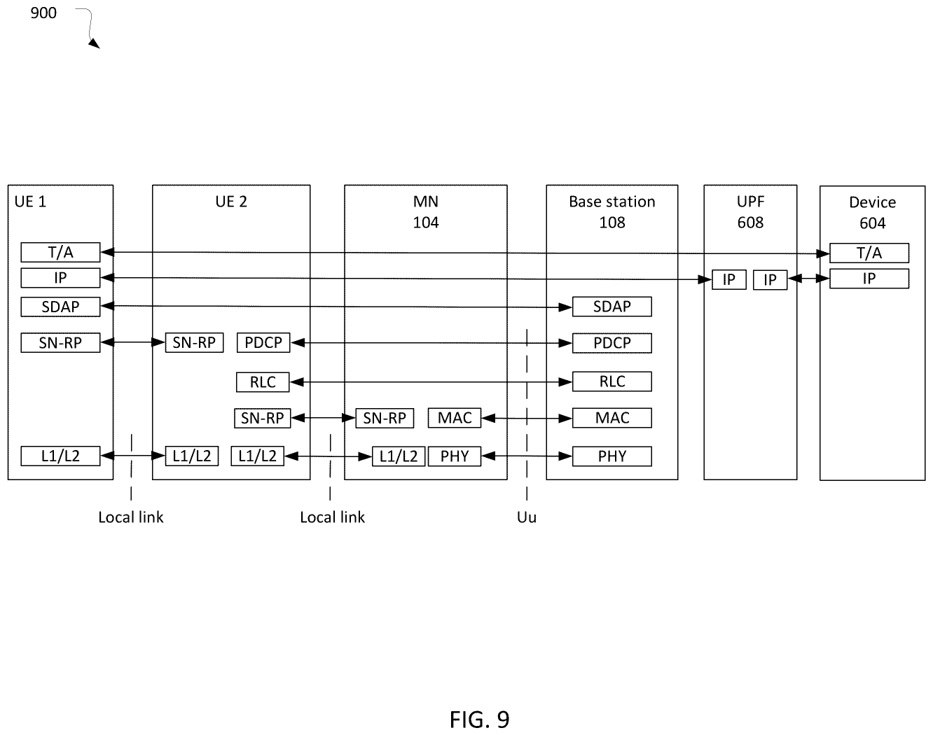

FIG. 9 illustrates a protocol configuration 900 with an SN-RP layer disposed directly below an SDAP layer on UE 1 in accordance with some embodiments.

IP/PDU sessions may terminate at UE 1, which may maintain QoS flow filtering per PDU session.

Operation of the protocol configuration 900 may be similar to that described above with respect to protocol configurations 700 or 800. However, the protocol configuration 900 may include the SDAP terminating at UE 1 (instead of terminating at UE 2 or MN 104), which may allow the QoS flow ID mapping to happen at the UE 1. The protocol configuration 900 may further include the RLC terminating at UE 2 (instead of terminating at MN 104), which may allow the RLC ARQ and RLC-triggered re-establishment procedures to cover the Uu and the local link between the UE 2 and the MN 104.

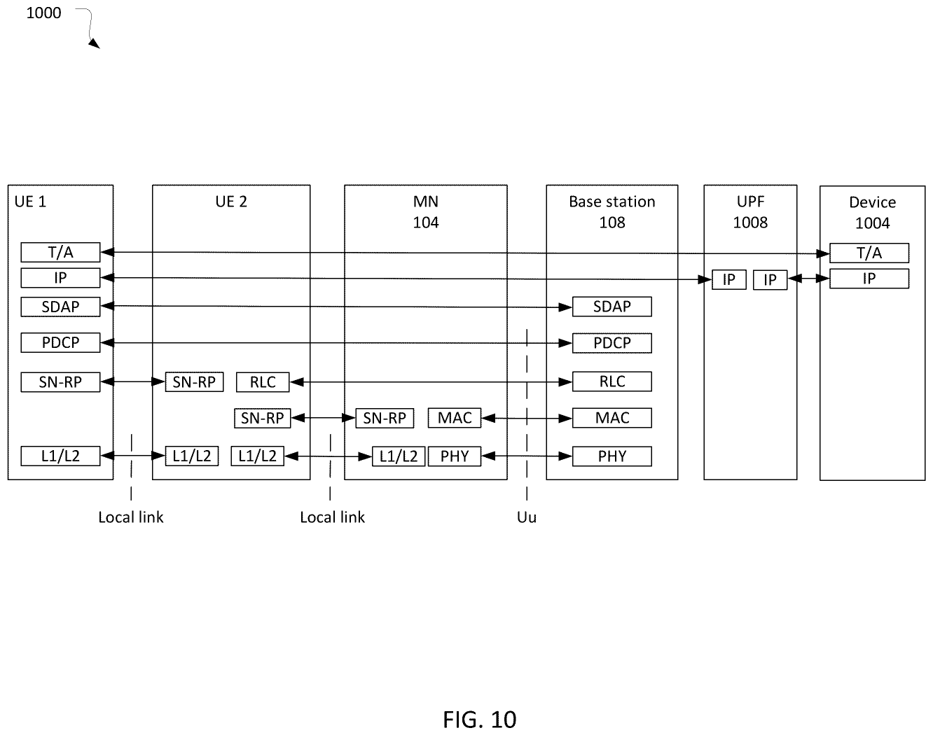

FIG. 10 illustrates a protocol configuration 1000 with an SN-RP layer disposed directly below a PDCP sublayer on UE 1 in accordance with some embodiments.

Operation of the protocol configuration 1000 may be similar to that described above with respect to protocol configuration 900. However, the protocol configuration 1000 may include the PDCP terminating at UE 1 (instead of terminating at UE 2). This may allow for PDCP functionality (for example, transfer of CP/UP data, header compression, ciphering, and integrity protection) to be performed at UE 1.

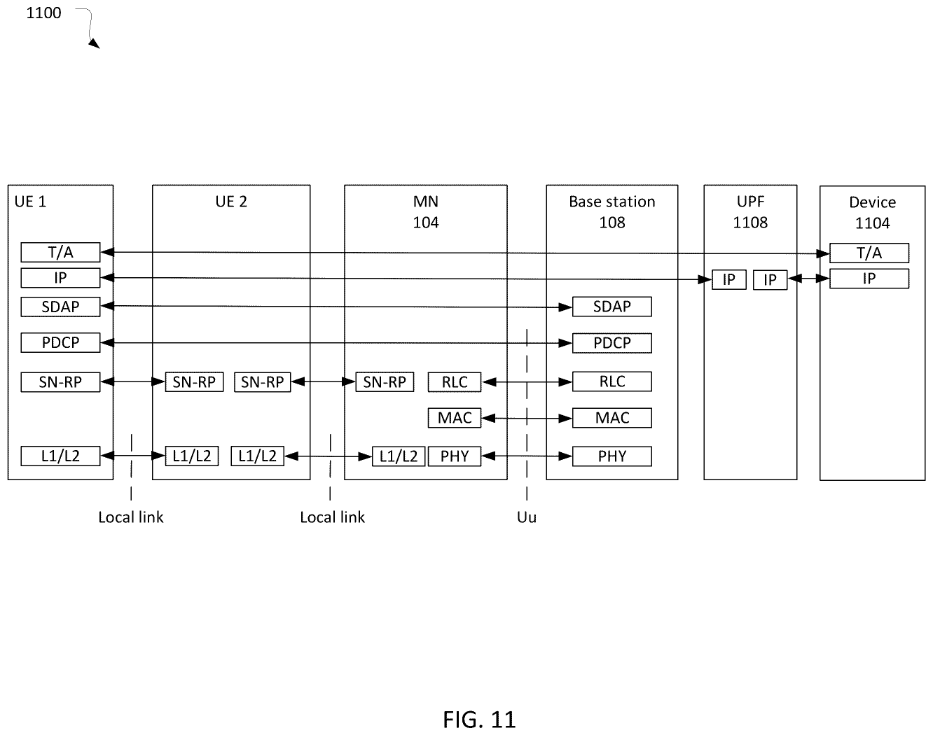

FIG. 11 illustrates a protocol configuration 1100 with an SN-RP layer disposed directly below a PDCP sublayer on UE 1 in accordance with some embodiments.

Operation of the protocol configuration 1100 may be similar to that described above with respect to protocol configuration 1000. However, the protocol configuration 1100 may include the RLC terminating at MN 104 (instead of terminating at UE 2). This may offload the RLC functionality to the MN 104 and rely on the MN 104 to pass relevant information through SN-RP routing of the subnetwork.

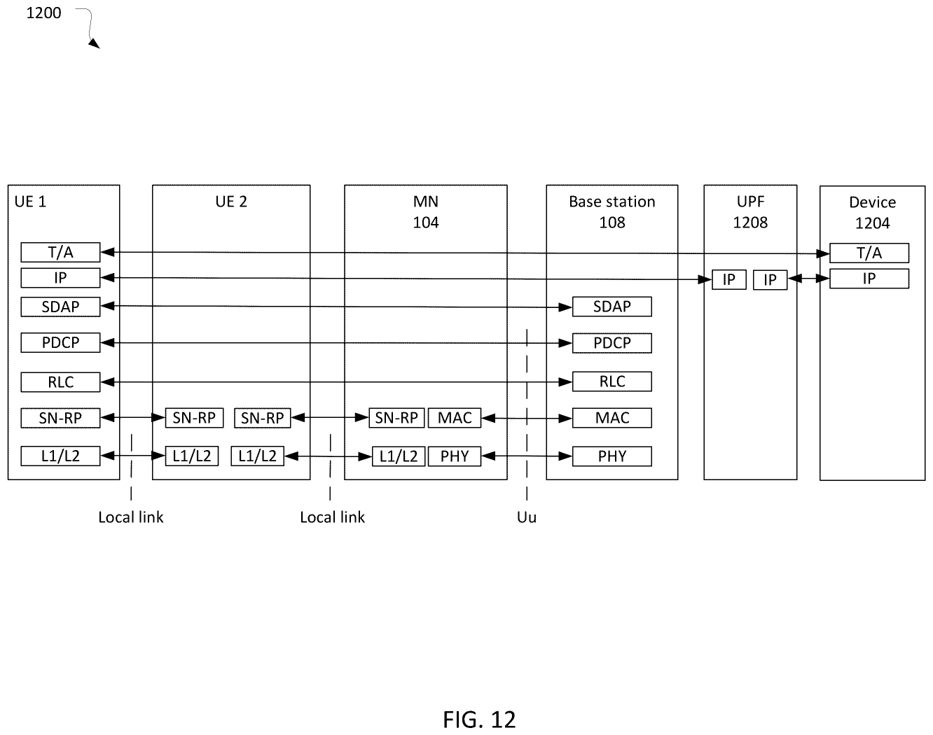

FIG. 12 illustrates a protocol configuration 1200 with an SN-RP layer disposed directly below an RLC sublayer on UE 1 in accordance with some embodiments.

Operation of the protocol configuration 1200 may be similar to that described above with respect to protocol configuration 1100. However, the protocol configuration 1200 may include the RLC terminating at UE 1 (instead of terminating at MN 104). This may provide the RLC functionality at the UE 1, while MAC functionality is offloaded to the MN 104, which may then pass relevant information through SN-RP routing of the subnetwork.

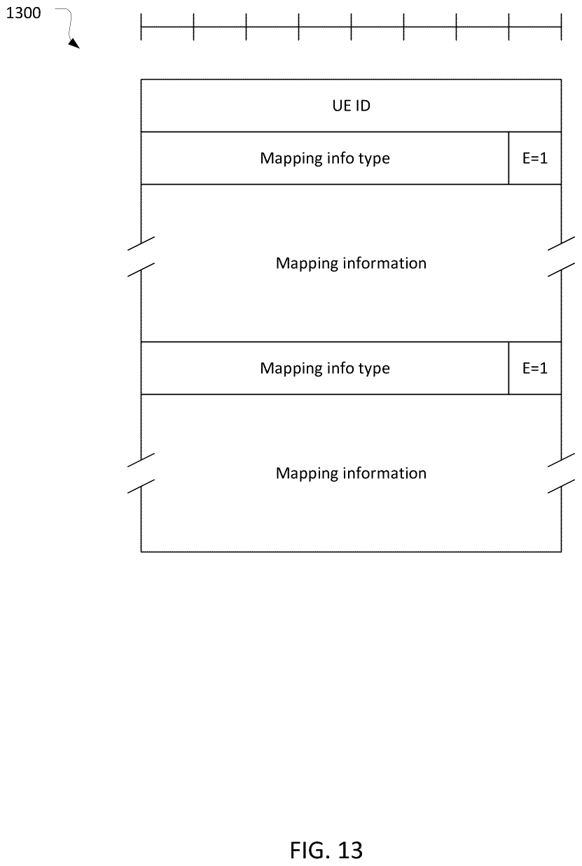

FIG. 13 illustrates an SN-RP header 1300 that may be used in accordance with some embodiments.

The SN-RP header 1300 may include a field for a UE ID that identifies a target subnetwork node to which the SN-RP packet is to be transmitted. In some embodiments, the UE ID may be eight bits. However, the UE ID may be other sizes in other embodiments.

The SN-RP header 1300 may further include a field for mapping information type. In some embodiments, the mapping information type may be seven bits. However, the mapping information type may be other sizes in other embodiments.

The mapping information type may be a value that defines how to interpret the mapping information that is to follow in the next x octets. Thus, the SN-RP header 1300 may use a Tag (for example, mapping information type)+Value (for example, mapping information) scheme to provide a flexible way to communicate relevant information for SN-RP signaling.

Example tag+value pairs include: mapping information tag of 0x00 may indicate the mapping information includes PDU session information (for example, 32-bit PDU session information); mapping information tag of 0x01 may indicate the mapping information includes DRB information (for example, a 16-bit DRB ID) mapping information tag of 0x002 may indicate the mapping information includes SRB information (for example, an 8-bit SRB ID). Other mappings, information types, and sizes of the mapping information may be used in other embodiments.

The mapping information field may be variable in size and may be specified by the preceding mapping information type.

An extension bit (E) may be provided after each mapping information type field. A first value of the extension bit (for example, E=1), may indicate an additional tag-value pair (for example, an additional mapping information type+mapping information pair). A second value of the extension bit (for example, UE=0), may mark this mapping information type plus mapping information pair is the last in the SN-RP header 1300.

Providing the snCP and snUP technologies describe herein may be associated with a number of benefits as compared to integraed access backhaul (IAB) and sidelink (SL) relays. For example, the MN-controlled subnetworks can use any technology and licensed/unlicensed spectrum, which may increase flexibility.

Further, as compared to IAB/SL Relay, the intra-subnetwork link scheduling, node configuration, and mobility may not be visible to the global NW. This may increase subnetwork transparency. For example, the Uu layer deployment may be fully flexible within the subnetwork and transparent to the NW. This may also reduce complexity in the global NW. For example, the base station 108 remains the anchor for the UEs and schedules UEs behind the MN 104 in the same way as UEs directly connected to the BS 108. For another example, the subnetwork 106 is not controlled by the global NW and, therefore, the internals may be transparent. Topology changes in the subnetwork do not need global NWs involvement, except for the possible exception of inter-MN mobility or UEs entering/leaving the subnetwork 106

In some embodiments, MN-controlled subnetworks move the subnetwork formation/control towards the UEs. In these embodiments, the use case may change from a network operator-owned use case, towards a UE/subscriber-owned use case.

As compared to IAB/SL relay, the QoS of an MN-controlled subnetwork may be managed by the base station from outside the subnetwork, without full control over the subnetwork. In IAB, the base station handles aggregated traffic from its child IAB node(s) and configures and controls all IAB nodes along the path. In SL relay the base station schedules the PC5 links along the path (Mode1) or the UEs autonomously communicate in D2D fashion (Mode2), there is no MN-controlled subnetwork.

In MN-controlled subnetworks, the base station of the RAN may maintain E2E QoS per UE and per UE's LC. This may be done by scheduling UEs individually while the subnetwork characteristics (for example, bandwidth limitations and latency/scheduling constraints) are abstracted to the broader network.

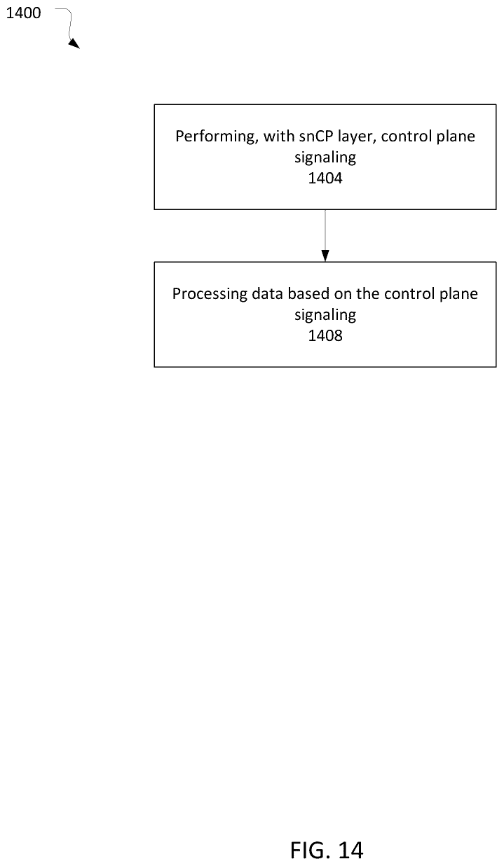

FIG. 14 is an operation flow/algorithmic structure 1400 in accordance with some embodiments. For example, the operation flow/algorithmic structure 1400 may be executed by a subnetwork UE, such as MN 104, UE 1, UE 2, UE 3, UE 1600, or components thereof, for example, processors 1604.

The operation flow/algorithmic structure 1400 may include, at 1404, performing control plane signaling with a node of a subnetwork. The node may be an MN of the subnetwork or a subnetwork UE. The control plane signaling may be snCP signaling performed by an snCP layer of the UE implementing the operation flow/algorithmic structure 1400. The implementing UE may be the MN of the subnetwork or a subnetwork UE coupled with the MN.

The operation flow/algorithmic structure 1400 may further include, at 1408, data received from the RAN or transmitted to the RAN. The data processed may be CP data (for example, control signaling) or UP data (for example, user data).

In some embodiments, in addition to the snCP signaling, the operation flow/algorithmic structure may include nwCP signaling. The nwCP signaling may be performed by an nwCP layer of the UE implementing the operation flow/algorithmic structure 1400 and an nwCP in the network (for example, a base station or core network). The snCP signaling may be based on the nwCP signaling and vice versa. For example, if the UE receives a message via nwCP signaling, it may, in turn transmit a message through the subnetwork using snCP signaling. The message transmitted by the snCP signaling may include at least some of the information from the message received via nwCP signaling. Conversely, if the UE receives a message via snCP signaling, it may, in turn transmit a message to the network using nwCP signaling. The message transmitted by the nwCP signaling may include at least some of the information from the message received via snCP signaling.

In some embodiments, the UE may offload a sublayer of an nwCP layer associated with the UE to another node. The other node may be an MN or another subnetwork UE. The offloading of the sublayer may be negotiated with the other node when the UE initially connects with the subnetwork. If the UE receives a message directed to the offloaded layer, the UE may transparently forward the message to the other node and receive information from the other node via snCP signaling.

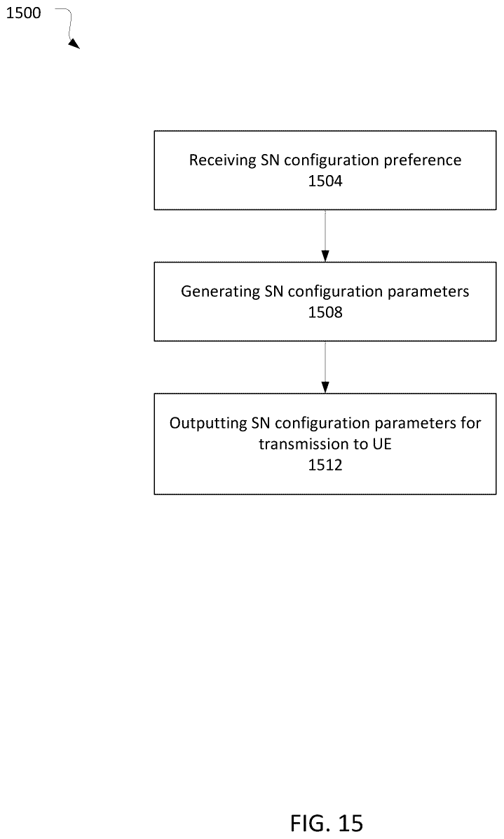

FIG. 15 is an operation flow/algorithmic structure 1500 in accordance with some embodiments. For example, the operation flow/algorithmic structure 1500 may be executed by MN 104, UE 1600, or components thereof, for example, processors 1604.

The operation flow/algorithmic structure 1500 may include, at 1504, receiving a subnetwork configuration preference. The subnetwork configuration preference may be received from a UE that is joining a subnetwork managed by the MN. The subnetwork configuration preference may indicate a preference of the joining UE for a particular protocol configuration for snUP signaling.

The operation flow/algorithmic structure 1500 may further include, at 1508, generating subnetwork configuration parameters based on the preference indicated. The configuration parameters may provide a protocol configuration for an snUP. The generated configuration parameters may be based on the subnetwork configuration preference. However, the snUP configured by the configuration parameters may or may not fully meet the requested preferences. This may be the case if the MN needs to account for other conditions or constraints of the subnetwork.

The operation flow/algorithmic structure 1500 may further include, at 1512, outputting the subnetwork configuration parameters for transmission to the UE. Thereafter, the MN and the UE may perform snUP signaling over the snUP configured by the configuration parameters.

The snUP may include a snUP layer at the UE that communicates with an snUP layer at the MN. In some embodiments, one or more intermediate nodes may have snUP layers that facilitate an indirect connection between the UE and the MN.

While FIGS. 14 and 15 may imply an order of the operation, it should be understood that the operations may be performed in a different order or one or more of the operations may be performed concurrently in other embodiments. Additionally, it should be understood that one or more additional operations may be included in the operation flows/algorithmic structure or one or more of the operations may be omitted in other embodiments.

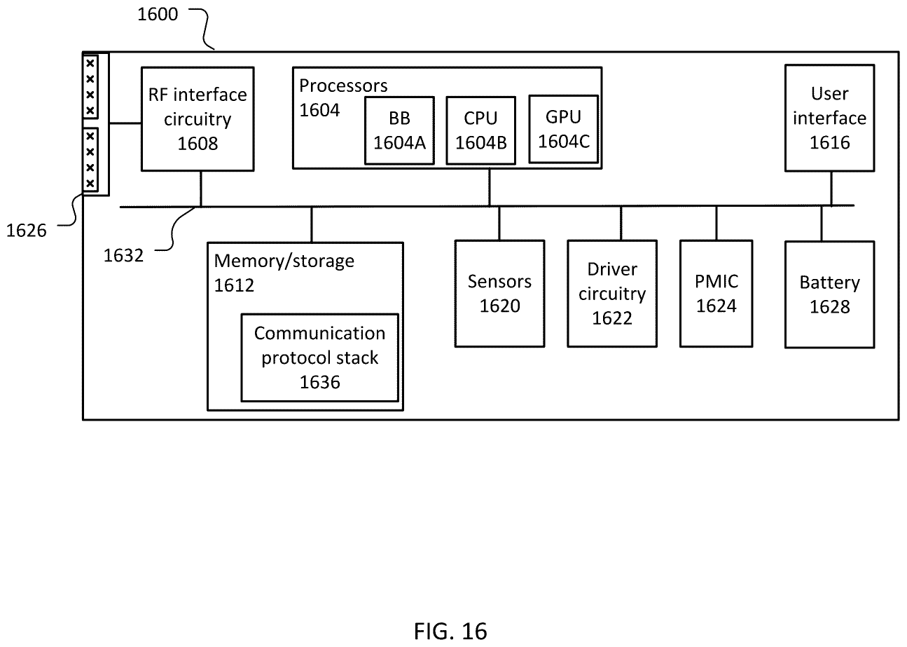

FIG. 16 illustrates an example UE 1600 in accordance with some embodiments. The UE 1600 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices.

The UE 1600 may include processors 1604, RF interface circuitry 1608, memory/storage 1612, user interface 1616, sensors 1620, driver circuitry 1622, power management integrated circuit (PMIC) 1624, antenna structure 1626, and battery 1628. The components of the UE 1600 may be implemented as integrated circuits (ICs), portions thereof, discrete electronic devices, or other modules, logic, hardware, software, firmware, or a combination thereof. The block diagram of FIG. 16 is intended to show a high-level view of some of the components of the UE 1600. However, some of the components shown may be omitted, additional components may be present, and different arrangement of the components shown may occur in other implementations.

The components of the UE 1600 may be coupled with various other components over one or more interconnects 1632, which may represent any type of interface, input/output, bus (local, system, or expansion), transmission line, trace, optical connection, etc. that allows various circuit components (on common or different chips or chipsets) to interact with one another.

The processors 1604 may include processor circuitry such as, for example, baseband processor circuitry (BB) 1604A, central processor unit circuitry (CPU) 1604B, and graphics processor unit circuitry (GPU) 1604C. The processors 1604 may include any type of circuitry or processor circuitry that executes or otherwise operates computer-executable instructions, such as program code, software modules, or functional processes from memory/storage 1612 to cause the UE 1600 to perform operations such as those described with respect to FIGS. 14 and 15 or elsewhere herein. In some embodiments, the instructions may implement CP/UP (sub) layers to perform some or all of these operations.

In some embodiments, the baseband processor circuitry 1604A may access a communication protocol stack 1636 in the memory/storage 1612 to communicate over a 3GPP compatible network. In general, the baseband processor circuitry 1604A may access the communication protocol stack to: perform user plane functions at a PHY layer, MAC layer, RLC layer, SN-TP layer, PDCP layer, SDAP layer, and PDU layer; and perform control plane functions at a PHY layer, MAC layer, RLC layer, snCP/UP layer, PDCP layer, RRC layer, and a non-access stratum layer. In some embodiments, the PHY layer operations may additionally/alternatively be performed by the components of the RF interface circuitry 1608.

The baseband processor circuitry 1604A may generate or process baseband signals or waveforms that carry information in 3GPP-compatible networks.

The memory/storage 1612 may include one or more non-transitory, computer-readable media that includes instructions (for example, communication protocol stack 1636) that may be executed by one or more of the processors 1604 to cause the UE 1600 to perform various operations described herein. The memory/storage 1612 include any type of volatile or non-volatile memory that may be distributed throughout the UE 1600. In some embodiments, some of the memory/storage 1612 may be located on the processors 1604 themselves (for example, L1 and L2 cache), while other memory/storage 1612 is external to the processors 1604 but accessible thereto via a memory interface. The memory/storage 1612 may include any suitable volatile or non-volatile memory such as, but not limited to, dynamic random-access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1608 may include transceiver circuitry and radio frequency front module (RFEM) that allows the UE 1600 to communicate with other devices over a radio access network. The RF interface circuitry 1608 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1626 and proceed to filter and amplify (with a low-noise amplifier) the signal. The signal may be provided to a receiver of the transceiver that down-converts the RF signal into a baseband signal that is provided to the baseband processor of the processors 1604.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna structure 1626.

In various embodiments, the RF interface circuitry 1608 may be configured to transmit/receive signals in a manner compatible with NR access technologies.

The antenna structure 1626 may include antenna elements to convert electrical signals into radio waves to travel through the air and to convert received radio waves into electrical signals. The antenna elements may be arranged into one or more antenna panels. The antenna structure 1626 may have antenna panels that are omnidirectional, directional, or a combination thereof to enable beamforming and multiple input, multiple output communications. The antenna structure 1626 may include microstrip antennas, printed antennas fabricated on the surface of one or more printed circuit boards, patch antennas, phased array antennas, etc. The antenna structure 1626 may have one or more panels designed for specific frequency bands including bands in FR1 or FR2.

The user interface 1616 includes various input/output (I/O) devices designed to enable user interaction with the UE 1600. The user interface 1616 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1600.

The sensors 1620 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1622 may include software and hardware elements that operate to control particular devices that are embedded in the UE 1600, attached to the UE 1600, or otherwise communicatively coupled with the UE 1600. The driver circuitry 1622 may include individual drivers allowing other components to interact with or control various input/output (I/O) devices that may be present within, or connected to, the UE 1600. For example, driver circuitry 1622 may include a display driver to control and allow access to a display device, a touchscreen driver to control and allow access to a touchscreen interface, sensor drivers to obtain sensor readings of sensors 1620 and control and allow access to sensors 1620, drivers to obtain actuator positions of electro-mechanic components or control and allow access to the electro-mechanic components, a camera driver to control and allow access to an embedded image capture device, audio drivers to control and allow access to one or more audio devices.

The PMIC 1624 may manage power provided to various components of the UE 1600. In particular, with respect to the processors 1604, the PMIC 1624 may control power-source selection, voltage scaling, battery charging, or DC-to-DC conversion.

In some embodiments, the PMIC 1624 may control, or otherwise be part of, various power saving mechanisms of the UE 1600. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1600 may power down for brief intervals of time and thus save power. If there is no data traffic activity for an extended period of time, then the UE 1600 may transition off to an RRC_Idle state, where it disconnects from the network and does not perform operations such as channel quality feedback, handover, etc. The UE 1600 goes into a very low power state, and it performs paging where again it periodically wakes up to listen to the network and then powers down again. The UE 1600 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1628 may power the UE 1600, although in some examples the UE 1600 may be mounted deployed in a fixed location and may have a power supply coupled to an electrical grid. The battery 1628 may be a lithium-ion battery, a metal-air battery, such as a zinc-air battery, an aluminum-air battery, a lithium-air battery, and the like. In some implementations, such as in vehicle-based applications, the battery 1628 may be a typical lead-acid automotive battery.

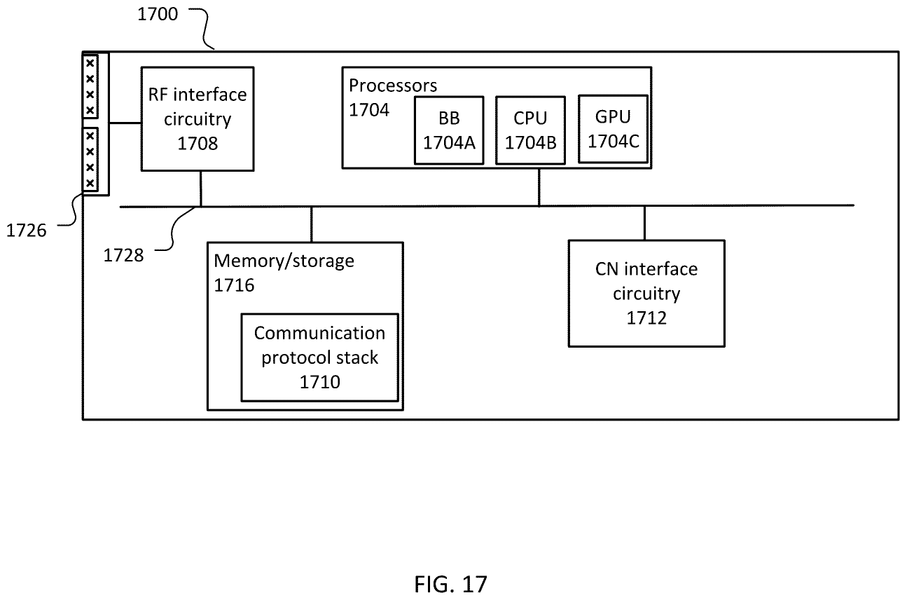

FIG. 17 illustrates an example base station 1700 in accordance with some embodiments. The base station 1700 may include processors 1704, RF interface circuitry 1708, core network (CN) interface circuitry 1712, memory/storage 1716, and antenna structure 1726.

The components of the base station 1700 may be coupled with various other components over one or more interconnects 1728.

The processors 1704, RF interface circuitry 1708, memory/storage 1716 (including communication protocol stack 1710), antenna structure 1726, and interconnects 1728 may be similar to like-named elements shown and described with respect to FIG. 16.

The processors 1704 may include any type of circuitry or processor circuitry that executes or otherwise operates computer-executable instructions, such as program code, software modules, or functional processes from memory/storage 1716 to cause the base station 1700 to perform operations such as those described with respect to base station 108 described elsewhere herein.

The CN interface circuitry 1712 may provide connectivity to a core network, for example, a 5th Generation Core network (5GC) using a 5GC-compatible network interface protocol such as carrier Ethernet protocols, or some other suitable protocol. Network connectivity may be provided to/from the base station 1700 via a fiber optic or wireless backhaul. The CN interface circuitry 1712 may include one or more dedicated processors or FPGAs to communicate using one or more of the aforementioned protocols. In some implementations, the CN interface circuitry 1712 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.
Example 1 includes a method to be implemented by a user equipment (UE), the method comprising: performing, with a subnetwork control plane (snCP) layer of the UE, control plane signaling with an snCP layer of a node of a subnetwork that is coupled with a radio access network (RAN), wherein the subnetwork is managed by a management node (MN); and processing, based on the control plane signaling, data received from the RAN or transmitted to the RAN.
Example 2 includes the method of example 1 or some other example herein, wherein the node is the MN, the control plane signaling is second control plane signaling, and the method further comprises: performing, with a network control plane (nwCP) layer of the UE, first control plane signaling with a nwCP layer of a base station of the RAN.
Example 3 includes a method of example 2 or some other example herein, wherein the second control plane signaling is based on the first control plane signaling.
Example 4 includes the method of example 1 or some other example herein, further comprising: offloading a sublayer of a network control plane (nwCP) layer of the UE to the node.
Example 5 includes the method of example 4 or some other example herein, further comprising: negotiating, with the node, the offloading of the sublayer upon an initial connection with the subnetwork.
Example 6 includes the method of example 4 or some other example herein, wherein the node is another UE connected with the MN and the method further comprises: receiving a message from an nwCP layer of a base station of the RAN; and transparently forwarding the message to the sublayer, wherein the control plane signaling includes receiving information contained in the message from the other UE.
Example 7 includes the method of example 1 or some other example herein, wherein the data is received from the RAN or transmitted to the RAN via a user plane of the subnetwork.
Example 8 includes a method to be implemented by a managing node (MN) of a subnetwork, the method comprising: receiving, from a user equipment (UE), a subnetwork configuration preference; generating, based on the subnetwork configuration preference, configuration parameters to configure a subnetwork user plane for transmitting data to the UE via the subnetwork or receiving data from the UE via the subnetwork; and outputting the configuration parameters for transmission to the UE.
Example 9 includes the method of example 8 or some other example herein, wherein the subnetwork user plane comprises: a subnetwork-routing protocol (SN-RP) layer at the UE; and an SN-RP layer at the MN to communicate with the SN-RP layer at the UE.
Example 10 includes the method of example 9 or some other example herein, wherein the SN-RP layer at the UE is directly below an Internet protocol (IP) layer at the UE and the method further comprises: receiving, at the SN-RP layer of the MN, an SN-RP packet that includes user data, a UE identifier (ID), and a protocol data unit (PDU) session ID or quality of service (QOS) flow ID; and mapping, with a service adaptation protocol (SDAP) layer of the MN, the user data to a data radio bearer based on the PDU session ID or QoS flow ID.
Example 11 includes the method of example 9 or some other example herein, wherein the SN-RP layer is directly below an Internet protocol (IP) layer at the UE and the method further comprises: receiving, at a service adaptation protocol (SDAP) layer of the MN, user data via a packet associated with a data radio bearer (DRB); mapping, with the SDAP layer of the MN based on the DRB, the user data to a quality of service (QOS) flow or protocol data unit (PDU) session; generating, with an SN-RP layer of the MN, an SN-RP packet to include the user data and an ID associated with the PDU session or an ID associated with the QoS flow; and outputting the SN-RP packet for transmission to an SN-RP layer of the UE.
Example 12 includes the method of example 8 or some other example herein, wherein the UE is a first UE and the subnetwork user plane comprises: a subnetwork-routing protocol (SN-RP) layer at the first UE; a first SN-RP layer at a second UE to communicate with the SN-RP at the first UE; a second SN-RP layer at the second UE; and an SN-RP layer at the MN to communicate with the second SN-RP layer at the second UE.
Example 13 includes the method of example 12 or some other example herein, wherein the SN-RP layer at the first UE is directly under an Internet protocol (IP) layer of the first UE and the second SN-RP layer at the second UE is directly under a packet data convergence protocol (PDCP) layer of the second UE.
Example 14 includes a method of example 12 or some other example herein, wherein the SN-RP layer at the first UE is directly under a packet data convergence protocol (PDCP) layer of the first UE, the second SN-RP layer at the second UE is directly under a radio link control (RLC) layer of the second UE.
Example 15 includes the method of example 12 or some other example herein, wherein the SN-RP layer at the first UE is directly under a packet data convergence protocol (PDCP) layer of the first UE and the SN-RP layer of the MN is to interface with a radio link control (RLC) layer of the MN.
Example 16 includes the method of example 12 or some other example herein, wherein the SN-RP layer at the first UE is directly under a radio link control (RLC) layer of the first UE and the SN-RP layer of the MN is to interface with a media access control (MAC) layer of the MN.
Example 17 includes the method of example 8 or some other example herein, wherein the subnetwork user plane comprises a subnetwork-routing protocol (SN-RP) layer at the UE and the method further comprises: generating an SN-RP packet that includes a header having a first field to indicate a UE identifier (ID), a second field to indicate a type of mapping information; and a third field to include mapping information of the type.
Example 18 includes the method of example 17 or some other example herein, wherein the type is a protocol data unit (PDU) session information type, a data radio bearer ID type, or a signaling radio bearer ID type.
Example 19 includes a method comprising: generating, with a subnetwork-routing protocol (SN-RP) layer, an SN-RP packet that includes a header having a first field to indicate a user equipment (UE) identifier (ID), a second field to indicate a type of mapping information; and a third field to include mapping information of the type; and transmitting the SN-RP to a subnetwork node via a direct connection over a local link.
Example 20 includes the method of example 19 or some other example herein, wherein the UE ID is to identify a UE that generates the SN-RP packet.
Example 21 includes the method of example 19 or some other example herein, wherein the type is a protocol data unit (PDU) session information type, a data radio bearer ID type, or a signaling radio bearer ID type.

Another example may include an apparatus comprising means to perform one or more elements of a method described in or related to any of examples 1-21, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-21, or any other method or process described herein.

Another example may include an apparatus comprising logic, modules, or circuitry to perform one or more elements of a method described in or related to any of examples 1-21, or any other method or process described herein.

Another example may include a method, technique, or process as described in or related to any of examples 1-21, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-21, or portions thereof.

Another example may include a signal as described in or related to any of examples 1-21, or portions or parts thereof.

Another example may include a datagram, information element, packet, frame, segment, PDU, or message as described in or related to any of examples 1-21, or portions or parts thereof, or otherwise described in the present disclosure.

Another example may include a signal encoded with data as described in or related to any of examples 1-21, or portions or parts thereof, or otherwise described in the present disclosure.

Another example may include a signal encoded with a datagram, IE, packet, frame, segment, PDU, or message as described in or related to any of examples 1-21, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-21, or portions thereof.

Another example may include a computer program comprising instructions, wherein execution of the program by a processing element is to cause the processing element to carry out the method, techniques, or process as described in or related to any of examples 1-21, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
performing, with a first subnetwork control plane (snCP) layer, control plane signaling with a second snCP layer, the second snCP layer associated with a node of a subnetwork that is coupled with a radio access network (RAN), wherein the subnetwork is managed by a management node (MN); and
processing, based on the control plane signaling, data received from the RAN or transmitted to the RAN.

2. The method of claim 1, wherein the node is the MN, the control plane signaling is second control plane signaling, and the method further comprises:
performing, with a first network control plane (nwCP) layer, first control plane signaling with a second nwCP layer, wherein the second nwCP layer is associated with a base station of the RAN.

3. The method of claim 2, wherein the second control plane signaling is based on the first control plane signaling.

4. The method of claim 1, further comprising:
offloading a sublayer of a network control plane (nwCP) layer to the node.

5. The method of claim 4, further comprising:
negotiating, with the node, the offloading of the sublayer upon an initial connection with the subnetwork.

6. The method of claim 4, wherein the node is a user equipment (UE) connected with the MN and the method further comprises:
receiving a message from an nwCP layer of a base station of the RAN; and
transparently forwarding the message to the sublayer,
wherein the control plane signaling includes receiving information contained in the message from the UE.

7. The method of claim 1, wherein the data is received from the RAN or transmitted to the RAN via a user plane of the subnetwork.

8. One or more non-transitory, computer-readable media having instructions that, when executed, cause processing circuitry to:
receive, from a user equipment (UE), a subnetwork configuration preference;
generate, based on the subnetwork configuration preference, configuration parameters to configure a subnetwork user plane for transmitting data to the UE via a subnetwork or receiving data from the UE via a subnetwork; and
output the configuration parameters for transmission to the UE.

9. The one or more non-transitory, computer-readable media of claim 8, wherein the subnetwork user plane comprises:
a subnetwork-routing protocol (SN-RP) layer at the UE; and
an SN-RP layer at a management node (MN) to communicate with the SN-RP layer at the UE.

10. The one or more non-transitory, computer-readable media of claim 9, wherein the SN-RP layer at the UE is directly below an Internet protocol (IP) layer at the UE and the instructions, when executed, further cause the processing circuitry to:
receive, at the SN-RP layer of the MN, an SN-RP packet that includes user data, a UE identifier (ID), and a protocol data unit (PDU) session ID or quality of service (QoS) flow ID; and
map, with a service adaptation protocol (SDAP) layer of the MN, the user data to a data radio bearer based on the PDU session ID or QoS flow ID.

11. The one or more non-transitory, computer-readable media of claim 9, wherein the SN-RP layer is directly below an Internet protocol (IP) layer at the UE and the instructions, when executed, further cause the processing circuitry to:
receive, at a service adaptation protocol (SDAP) layer of the MN, user data via a packet associated with a data radio bearer (DRB);
map, with the SDAP layer of the MN based on the DRB, the user data to a quality of service (QOS) flow or protocol data unit (PDU) session;
generate, with an SN-RP layer of the MN, an SN-RP packet to include the user data and an ID associated with the PDU session or an ID associated with the QoS flow; and
output the SN-RP packet for transmission to an SN-RP layer of the UE.

12. The one or more non-transitory, computer-readable media of claim 8, wherein the UE is a first UE and the subnetwork user plane comprises:
a subnetwork-routing protocol (SN-RP) layer at the first UE;
a first SN-RP layer at a second UE to communicate with the SN-RP layer at the first UE;
a second SN-RP layer at the second UE; and
an SN-RP layer at a management node (MN) to communicate with the second SN-RP layer at the second UE.

13. The one or more non-transitory, computer-readable media of claim 12, wherein the SN-RP layer at the first UE is directly under an Internet protocol (IP) layer of the first UE and the second SN-RP layer at the second UE is directly under a packet data convergence protocol (PDCP) layer of the second UE.

14. The one or more non-transitory, computer-readable media of claim 12, wherein the SN-RP layer at the first UE is directly under a packet data convergence protocol (PDCP) layer of the first UE, the second SN-RP layer at the second UE is directly under a radio link control (RLC) layer of the second UE.

15. The one or more non-transitory, computer-readable media of claim 12, wherein the SN-RP layer at the first UE is directly under a packet data convergence protocol (PDCP) layer of the first UE and the SN-RP layer of the MN is to interface with a radio link control (RLC) layer of the MN.

16. The one or more non-transitory, computer-readable media of claim 12, wherein the SN-RP layer at the first UE is directly under a radio link control (RLC) layer of the first UE and the SN-RP layer of the MN is to interface with a media access control (MAC) layer of the MN.

17. The one or more non-transitory, computer-readable media of claim 8, wherein the subnetwork user plane comprises a subnetwork-routing protocol (SN-RP) layer at the UE and the instructions, when executed, further cause the processing circuitry to:
generate an SN-RP packet that includes a header having a first field to indicate a UE identifier (ID), a second field to indicate a type of mapping information; and a third field to include mapping information of the type,
wherein the type is a protocol data unit (PDU) session information type, a data radio bearer ID type, or a signaling radio bearer ID type.

18. An apparatus comprising:
interface circuitry; and
processing circuitry coupled with the interface circuitry, the processing circuitry to:
generate, with a subnetwork-routing protocol (SN-RP) layer, an SN-RP packet that includes a header having a first field to indicate a user equipment (UE) identifier (ID), a second field to indicate a type of mapping information; and a third field to include mapping information of the type; and
output, via the interface circuitry, the SN-RP packet for transmission to a subnetwork node via a direct connection over a local link.

19. The apparatus of claim 18, wherein the UE ID is to identify a UE that generates the SN-RP packet.

20. The apparatus of claim 18, wherein the type is a protocol data unit (PDU) session information type, a data radio bearer ID type, or a signaling radio bearer ID type.
